(19) United States
(12) Patent Application Publication
(10) Pub. No.: US 2015/0028651 A1
(43) Pub. Date: Jan. 29, 2015

(54) Combination Structure of Safety Vest and Safety Belt for Vehicle Seat

(71) Applicants: Younhong Chung, Suwon-si (KR); Hyunwook Kim, Suwon-si (KR); Yongchul Shin, Suwon-si (KR)

(72) Inventors: Younhong Chung, Suwon-si (KR); Hyunwook Kim, Suwon-si (KR); Yongchul Shin, Suwon-si (KR)

(73) Assignee: THIRDEYE INC., Suwon-si (KR)

(21) Appl. No.: 14/072,608

(22) Filed: Nov. 5, 2013

(30) Foreign Application Priority Data
Jul. 25, 2013 (KR) 10-2013-0088188

(51) Int. Cl. B60R 22/32

(52) U.S. Cl. CPC B60R 22/32
USPC 297/465

(57) ABSTRACT

Disclosed herein is a combination structure of a safety vest and a safety belt. The combination structure is designed such that the safety vest and the safety belt are integrated with each other, so that a separate additional means for converting the safety vest to the safety belt is not required, and the safety and convenience in use can be improved.

### CROSS REFERENCE TO RELATED APPLICATION

This application claims the benefit of Korean Patent Application No. 10-2013-0088188, filed on Jul. 25, 2013, which is hereby incorporated by reference in its entirety into this application.

### BACKGROUND OF THE INVENTION

1. Technical Field

The present invention relates to a combination structure of a safety vest and a safety belt for a vehicle seat which is configured such that even children, disabled persons, the elderly, etc. can easily wear it.

2. Description of the Related Art

As vehicle-related technology is developed and the standard of living is enhanced, the number of elderly or disabled persons who use small electric vehicles for short distances is recently increased. However, in proportion to this, the number of traffic accidents is also increased. This has become a social problem.

A safety belt, provided to ensure safety of a passenger when a traffic accident occurs, is an important element of a vehicle. Wearing such a safety belt is required by law to reduce human injury.

Safety belts for vehicles are classified into two-point safety belts and three-point safety belts. Three-point safety belts are used in most passenger cars, and two-point safety belts are used in most large buses.

However, because existing safety belts for vehicles are typically designed and manufactured based on an adult body type, they are not suitable for children, disabled persons or the elderly.

Particularly, three-point safety belts are designed such that they hold the shoulders of passengers when the vehicle suddenly stops or is involved in collision accidents. However, in the case where the passengers are children, disabled persons or the elderly, safety belts may injure them with strong pressure.

The two-point safety belts are designed for pressing the abdominal portions of adult body type passengers. Thus, if the passengers are children, disabled persons or the elderly, excessive pressure is applied to the abdominal portions, so the safety belts may cause injury, or the safety belts may not be able to hold the bodies of the passengers on the seat whereby the bodies of the passengers may be undesirably thrown from the seats and collide with other objects.

In other words, conventional safety belts are problematic in that they may not perform the intended function of holding passengers on seats when vehicles are driven or impacts occur (e.g., when an accident occurs) thus failing to prevent passengers from being undesirably thrown from their seats or from the vehicles themselves and suffering secondary injury.

Different kinds of safety devices which can substitute for safety belts were proposed to overcome the above-mentioned problems.

For example, a safety device was proposed in Korean Utility Model Publication No. 1993-25461 (Publication date: Dec. 20, 1993), entitled “Vehicle safety device for children”, in which fasteners are provided on both shoulder parts and both waist parts of a vest and are fastened to corresponding support buckles.

In this vehicle safety device for children, the fasteners are fastened to a vest body by sewing such that the fasteners can be used in such a way as to be hooked to a vehicle seat rather than to be connected to a safety belt provided on the vehicle seat. When a comparatively large impact is applied to the safety device, fabric by which each fastener is fastened to the vest body may be separated from the vest body, thus causing safety problems.

As another example, a multipurpose safety vest was proposed in Korean Patent Registration No. 10-0790437 (Registration date: Dec. 24, 2007). The multipurpose safety vest includes a vest body. A pair of shoulder-holding female buckles which are fastened to a headrest and a pair of abdomen-holding female buckles which are fastened to the seatback of a vehicle seat are coupled to the vest body by first and second coupling bands. A coupling unit which fastens the vest body to the body of a user and a plurality of fastening clips into which a portion of a safety belt that holds the abdomen of the user is inserted are provided on the vest body. A safety sign is provided on a rear surface of a back part of the vest body.

The conventional multipurpose safety vest is configured such that it is connected to the safety belt provided on the vehicle seat, but the safety belt and the safety vest are separately provided from each other rather than being integrated with each other. Furthermore, because fastening-related elements of the safety vest must be connected one after another to the safety belt, the headrest or the seatback, the structure thereof is complex and it is inconvenient to use.

### SUMMARY OF THE INVENTION

Accordingly, the present invention has been made keeping in mind the above problems occurring in the prior art, and an object of the present invention is to provide a combination structure of a safety vest and a safety belt which has a simple integrated structure so that a separate additional means for converting the safety vest to the safety belt is not required, and the safety and convenience in use can be improved.

In order to accomplish the above object, the present invention provides a combination structure of a safety vest and a safety belt for a vehicle seat, including: a safety belt worn on an upper body of a user, with a bracket provided in a central portion of a rear surface of the safety belt; a belt fastening module installed in a central portion of a front surface of a seatback of the vehicle seat so that the bracket is locked to the belt fastening module; a belt release lever unit installed in a seat cushion of the vehicle seat; and a cable connecting the belt release lever unit to the belt fastening module so that when the belt release lever unit is pulled, the cable is pulled, thus releasing the bracket from the belt fastening module.

The bracket may be made of either metal or synthetic resin to prevent the bracket from being deformed by strong impact or high pressure.

The bracket may have, on a periphery thereof, an inclined surface reduced in width from a front thereof to a rear so that when the bracket is locked to the belt fastening module, the bracket can slide into the belt fastening module, with locking holes respectively formed in upper, lower, left and right portions of a periphery of the inclined surface so that the bracket is locked to the belt fastening module through the locking holes.

A luminous substance for night vision may be formed on an outer surface of the safety belt.

The belt fastening module may include: a module body fixed in the seatback of the vehicle seat, with an insert hole formed in a front surface of the module body so that the bracket is inserted into the insert hole; a plurality of locking blocks respectively provided in upper, lower, left and right positions of an inner peripheral surface of the module body, the locking blocks being connected to the cable and configured such that the locking blocks are extracted by predetermined distances towards a center of the insert hole or retracted backwards and thus locked to or removed from the corresponding locking holes of the bracket; and a plurality of coil springs respectively installed in the upper, lower, left and right portions of the peripheral surface of the module body, each of the coil springs moving the corresponding locking block forwards using elastic force thereof.

The belt release lever unit may include: a lever unit body fixed in the seat cushion of the vehicle seat, with a depression formed in the lever unit body; and a lever hinged to the lever unit body at an upper end of the depression, the lever being connected at a predetermined position to the cable so that when the lever is pulled upwards, the lever pulls the cable.

The cable may be installed by a connection unit provided in the vehicle seat in such a way that a first end of the cable branches off in a plurality of cable parts that are connected to the respective locking blocks installed in the belt fastening module, and a second end of the cable forms a single cable part and is connected to the lever of the belt release lever unit.

The connection unit may include: a guide part fixed in the vehicle seat, the guide part maintaining intervals between the plurality of cable parts of the cable to prevent the plurality of cable parts from being entangled with each other; and a pulling part facing a side of the guide part with a predetermined distance therebetween, the pulling part being connected both to ends of the plurality of cable parts that extend from the guide part and to an end of the single cable part and provided so as to be movable towards or away from the pulling part.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating a combination structure of a safety vest and a safety belt with a bracket, according to the present invention;

FIG. 2 is a perspective view showing a belt fastening module and a belt release lever installed in a seat according to the present invention;

FIG. 3 is a perspective view showing a bracket of a safety belt that faces the belt fastening module of the seat according to the present invention;

FIG. 4 is an external perspective view illustrating the operation of the belt release lever according to the present invention;

FIG. 5 is an internal perspective view illustrating the operation of the belt release lever according to the present invention;

FIGS. 6A, 6B and 6C illustrate a process of fastening a bracket of the safety belt to the belt fastening module according to the present invention; and

FIGS. 7A, 7B and 7C illustrate a process of releasing the bracket of the safety belt from the belt fastening module according to the present invention.

### DESCRIPTION OF THE PREFERRED EMBODIMENTS

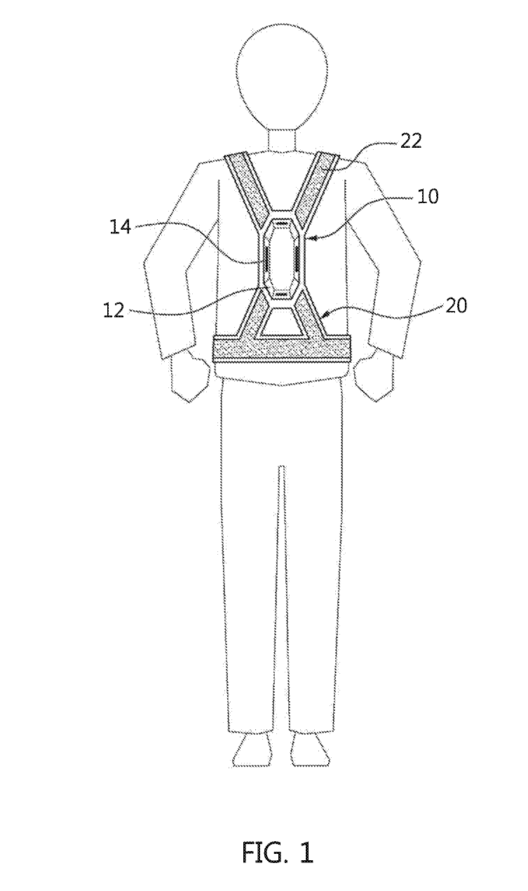

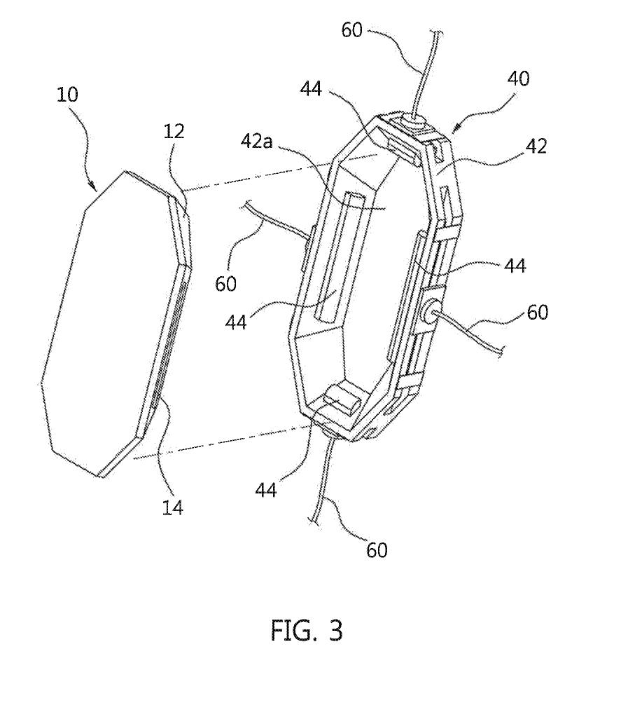

Hereinafter, an embodiment of the present invention will be described in detail with reference to FIGS. 1 through 7.

Reference now should be made to the drawings, throughout which the same reference numerals are used to designate the same or similar components.

A combination structure of a safety vest and a safety belt for a vehicle seat according to the present invention includes a safety belt 20, a belt fastening module 40, a belt release lever unit 50 and a cable 60.

In detail, the safety belt 20 is put on the upper body of a user who sits on the seat 30. A bracket 10 is fixed on a central portion of a rear surface of the safety belt 20. The belt fastening module 40 is installed in a central portion of a front surface of a seatback 32 of the seat 30 so that the bracket 10 can be locked to the belt fastening module 40. The belt release lever unit 50 is installed in a central portion of a front end of the seat cushion 34 of the seat 30. The cable 60 connects the belt fastening module 40 to the belt release lever unit 50 so that when the belt release lever unit 50 is pulled, the cable 60 is pulled, thus releasing the bracket 10 from the belt fastening module 40.

The bracket 10 is made of either metal or synthetic resin having sufficient strength to prevent it from being deformed by strong impact or high pressure. Reduced in width from the front to the rear, an inclined surface 12 is formed around a periphery of the bracket 10 so that when the bracket 10 is locked to the belt fastening module 40, it can smoothly slide. Locking holes 14 are respectively formed in upper, lower, left and right portions of the periphery of the inclined surface 12 so that the bracket 10 can be locked to the belt fastening module 40.

The safety belt 20 has a band structure and is provided with a coupling means such as Velcro tape, buckle, etc. so that the user can easily put on the safety belt 20 or take it off. Furthermore, a luminous substance 22 for night vision is attached or applied to an outer surface of the safety belt 20.

The belt fastening module 40 includes a module body 42 which has an insert hole 42a therein, a plurality of locking blocks 44 and a plurality of coil springs 46.

In detail, the module body 42 is fixed in the seatback 32 of the seat 30 and has an insert hole 42a in a front surface thereof so that the bracket 10 can be inserted into the insert hole 42a. The locking blocks 44 are respectively provided in upper, lower, left and right positions of an inner peripheral surface of the module body 42. The locking blocks 44 are configured such that they can be extracted by predetermined distances towards the center of the insert hole 42a or retracted backwards and thus locked to or removed from the corresponding locking holes 14 of the bracket 10. The cable 60 is connected to the locking blocks 44. The coil springs 46 are respectively installed in the upper, lower, left and right portions of the peripheral surface of the module body 42. Each coil spring 46 functions to elastically move the corresponding locking block 44 forwards.

The belt release lever unit 50 includes a lever unit body 52 which has a depression 52a therein, and a lever 54.

In detail, the lever unit body 52 is fixed in the seat cushion 34 of the seat 30, and the depression 52a is formed in the lever unit body 52. The lever 54 is hinged to the lever unit body 52 at an upper end of the depression 52a. The cable 60 is connected to a predetermined portion of the lever 54 so that when the user pulls the lever 54 upwards, the lever 54 can pull the cable 60.

The cable 60 is installed by a connection unit 70 provided in the seat 30 such that a first end of the cable 60 branches off into several cable parts that are connected to the respective locking blocks 44 installed in the belt fastening module 40, and a second end of the cable 60 forms a single cable part and is connected to the lever 54 of the belt release lever unit 50.

The connection unit 70 includes a guide part 72 and a pulling part 74. The guide part 72 is fixed in the seat 30 and functions to maintain intervals between the several cable parts of the cable 60, thus preventing the several cable parts from being entangled with each other. The pulling part 74 faces a side of the guide part 72 with a predetermined distance therebetween. The pulling part 74 is connected to ends of the several cable parts that extend from the guide part 72 and also connected to an end of the single cable part of the cable 60. The pulling part 74 can move towards or away from the guide part 72.

The operation and effect of the safety vest and safety belt combination structure according to the present invention having the above-mentioned construction will be explained below.

First, as shown in FIG. 1, when the user wears the safety belt 20, the bracket 10 that is fixed to the safety belt 20 is reliably disposed on a central portion of the upper body of the user. Because the luminous substance 22 formed on the surface of the safety belt 20 emits light in the dark, the safety belt 20 can be used as a safety vest when walking at night.

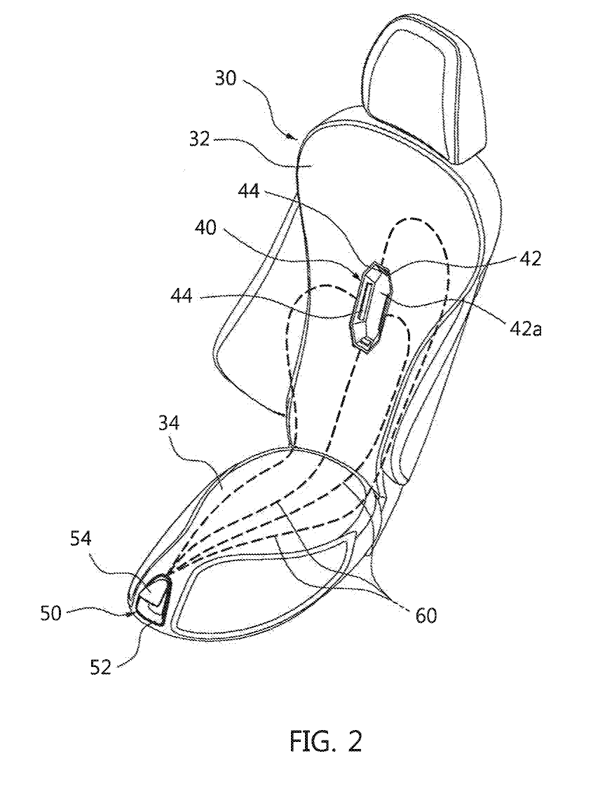

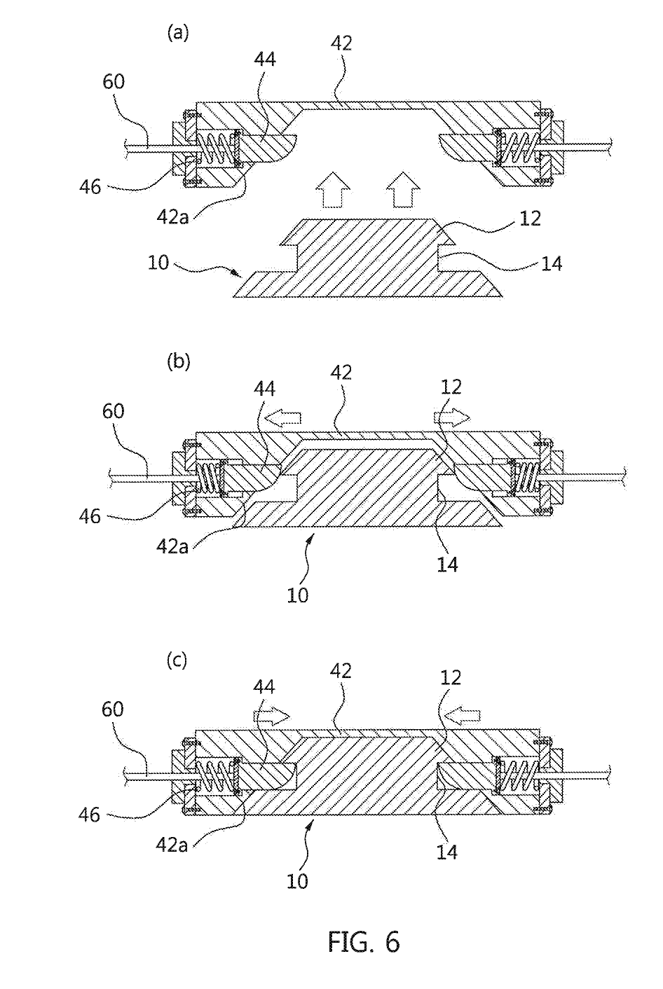

In this state, the user who has put on the safety belt 20 sits on the vehicle seat 30 shown in FIG. 2, bring his/her back into close contact with the seatback 32 of the seat 30 and, as shown in FIG. 6A, and pushes the bracket 10 provided on the safety belt 20 into the belt fastening module 40 installed in the seatback 32. Then, as shown in FIG. 6B, the inclined surface 12 of the bracket 10 is inserted into the insert hole 42a of the belt fastening module 40 while coming into contact with the locking blocks 44 that protrude inwards from the upper, lower, left and right side surfaces of the insert hole 42a and pushing the locking blocks 44 outwards.

When the bracket 10 is completely inserted into the insert hole 42a of the belt fastening module 40, as shown in FIG. 6C, the locking holes 14 which are formed in the upper, lower, left and right portions of the inclined surface 12 correspond to the respective locking blocks 44. Then, the locking blocks 44 are extracted forwards by the elastic force of the coil spring 46, and the ends of the locking blocks 44 are inserted into the corresponding locking holes 14. Thereby, the bracket 10 of the safety belt 20 is reliably fastened to the belt fastening module 40 of the seat 30.

As such, the bracket 10 of the safety belt 20 can be fastened to the belt fastening module 40 of the seatback 32 in a one-touch manner merely by a single action in which the user pushes his/her back onto the seatback 32 without using his/her hand. Thus, children, disabled persons, the elderly, etc. can easily use the present invention.

Furthermore, because the safety belt 20 is coupled to the seat 30 around the back of the upper body of the user, the user who is sitting on the seat 30 can be maintained in a stable sitting posture. By virtue of the stable sitting posture, when the vehicle is involved in a collision accident or severely wobbles, the user can be prevented from injury.

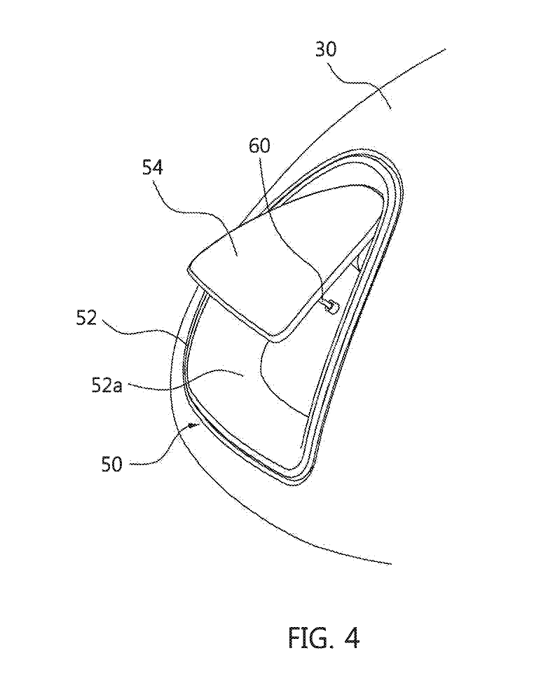

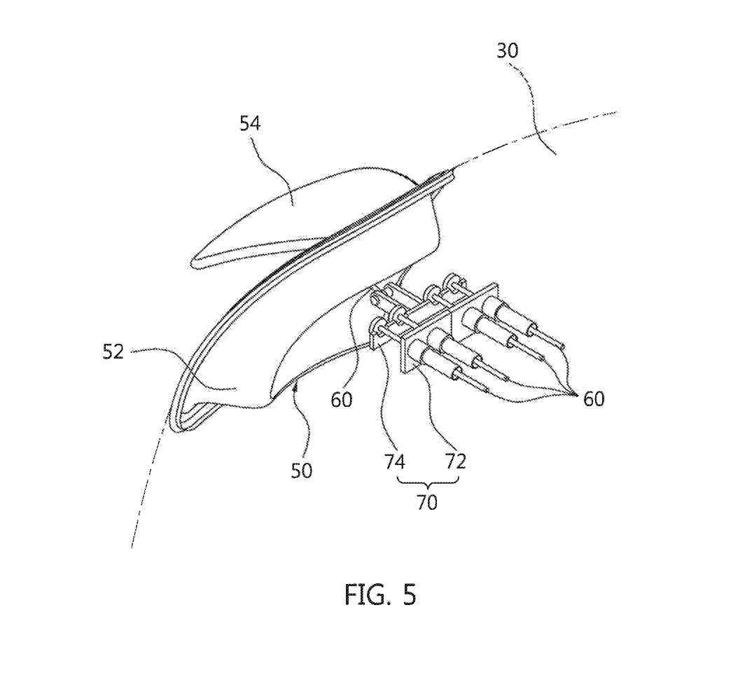

Meanwhile, to remove the bracket 10 of the safety belt 20 from the belt fastening module 40 of the seat 30, as shown in FIG. 4, the user pulls the lever 54 of the belt release lever unit 50 that is installed in the seat cushion 34 of the seat 30. Then, the lever 54 is rotated around the hinge point, thus pulling the cable 60 connected to the predetermined portion of the lever 54. As shown in FIG. 5, the cable 60 pulls the locking blocks 44 through the connection unit 70 at the same time.

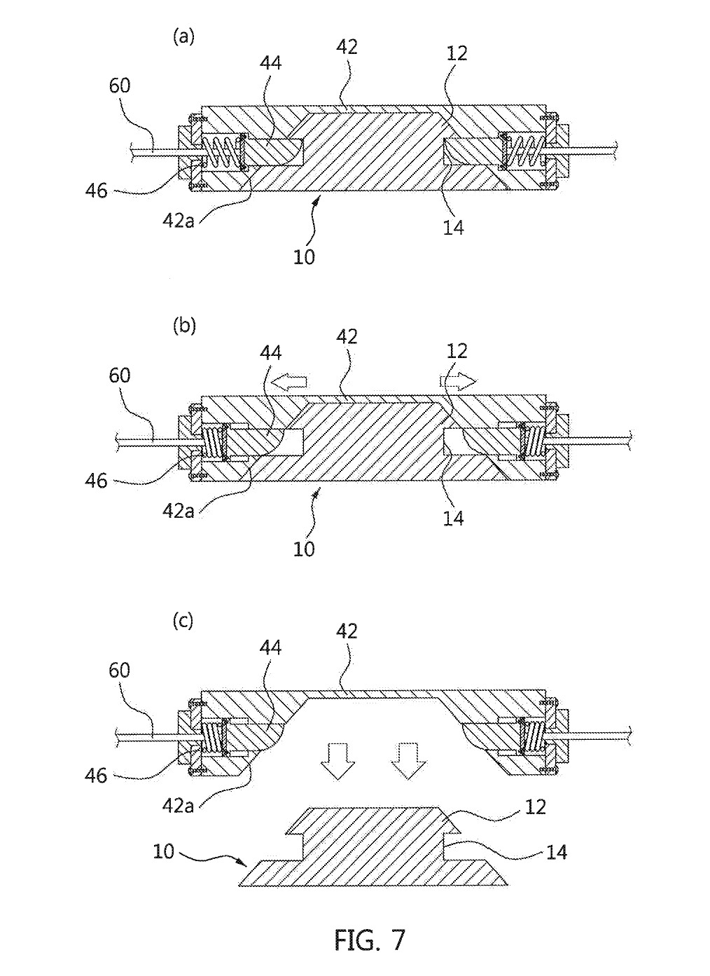

As a result, according to the operation sequence of FIGS. 7A, 7B and 7C, the locking blocks 44 are moved backwards along guide holes formed in the module body 42 of the belt fastening module 40, and the ends of the locking blocks 44 are removed from the locking holes 14 of the bracket 10. Then, the bracket 10 enters a state in which it can be released from the belt fastening module 40.

In this state in which the bracket 10 is released, if the user bends his/her upper body forwards, the bracket 10 fixed on the safety belt 20 is moved away from the belt fastening module 40.

Subsequently, when the user releases the lever 54, the locking blocks 44 are extracted forwards by the elastic force of the coil springs 46 provided in the module body 42 of the belt fastening module 40 and is returned to their initial state in which the ends of the locking blocks 44 protrude predetermined lengths into the insert hole 42a. Because of the forward movement of the locking blocks 44, the several cable parts of the cable 60 that are connected to the locking blocks 44 are pulled at the same time by the locking blocks 44, whereby the lever 54 of the belt release lever unit 50 that is connected to the end of the cable 60 is returned to its original position.

As described above, the present invention provides a combination structure of a safety vest and a safety belt which is configured as a simple integrated structure such that when a user enters a vehicle and sits on a seat of the vehicle, the combination structure is locked to a coupling means of the seat so that it can be used as a safety seat belt, and when the user is not in the vehicle and walks at night, the combination structure can be used as a safety vest. A separate additional means is not required to convert the safety vest to a safety belt. In addition, the present invention can provide improved safety and enhanced convenience in use.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A combination structure of a safety vest and a safety belt for a vehicle seat, comprising:
a safety belt worn on an upper body of a user, with a bracket provided in a central portion of a rear surface of the safety belt;
a belt fastening module installed in a central portion of a front surface of a seatback of the vehicle seat so that the bracket is locked to the belt fastening module;
a belt release lever unit installed in a seat cushion of the vehicle seat; and
a cable connecting the belt release lever unit to the belt fastening module so that when the belt release lever unit is pulled, the cable is pulled, thus releasing the bracket from the belt fastening module.

2. The combination structure of the safety vest and the safety belt set forth in claim 1, wherein the bracket is made of either metal or synthetic resin to prevent the bracket from being deformed by strong impact or high pressure.

3. The combination structure of the safety vest and the safety belt set forth in claim 1, wherein the bracket has, on a periphery thereof, an inclined surface reduced in width from a front thereof to a rear so that when the bracket is locked to the belt fastening module, the bracket can slide into the belt fastening module, with locking holes respectively formed in upper, lower, left and right portions of a periphery of the inclined surface so that the bracket is locked to the belt fastening module through the locking holes.

4. The combination structure of the safety vest and the safety belt set forth in claim 1, wherein a luminous substance for night vision is formed on an outer surface of the safety belt.

5. The combination structure of the safety vest and the safety belt set forth in claim 1, wherein the belt fastening module comprises:
a module body fixed in the seatback of the vehicle seat, with an insert hole formed in a front surface of the module body so that the bracket is inserted into the insert hole;
a plurality of locking blocks respectively provided in upper, lower, left and right positions of an inner peripheral surface of the module body, the locking blocks being connected to the cable and configured such that the locking blocks are extracted by predetermined distances towards a center of the insert hole or retracted backwards and thus locked to or removed from the corresponding locking holes of the bracket; and
a plurality of coil springs respectively installed in the upper, lower, left and right portions of the peripheral surface of the module body, each of the coil springs moving the corresponding locking block forwards using elastic force thereof.

6. The combination structure of the safety vest and the safety belt set forth in claim 1, wherein the belt release lever unit comprises:
a lever unit body fixed in the seat cushion of the vehicle seat, with a depression formed in the lever unit body; and
a lever hinged to the lever unit body at an upper end of the depression, the lever being connected at a predetermined position to the cable so that when the lever is pulled upwards, the lever pulls the cable.

7. The combination structure of the safety vest and the safety belt set forth in claim 1, wherein the cable is installed by a connection unit provided in the vehicle seat in such a way that a first end of the cable branches off in a plurality of cable parts that are connected to the respective locking blocks installed in the belt fastening module, and a second end of the cable forms a single cable part and is connected to the lever of the belt release lever unit.

8. The combination structure of the safety vest and the safety belt set forth in claim 7, wherein the connection unit comprises:
a guide part fixed in the vehicle seat, the guide part maintaining intervals between the plurality of cable parts of the cable to prevent the plurality of cable parts from being entangled with each other; and
a pulling part facing a side of the guide part with a predetermined distance therebetween, the pulling part being connected both to ends of the plurality of cable parts that extend from the guide part and to an end of the single cable part and provided so as to be movable towards or away from the pulling part.
